(19) United States
(12) Patent Application Publication
(10) Pub. No.: US 2025/0207454 A1
(43) Pub. Date: Jun. 26, 2025

(54) WINDOW OR DOOR HOLLOW CHAMBER PROFILE AND WINDOW OR DOOR FRAME FORMED THEREFROM

(71) Applicant: REHAU INDUSTRIES SE & CO. KG, Rehau (DE)

(72) Inventors: Ahmad AL-SHEYYAB, Rehau (DE); Norbert FINK, Eckental (DE); Stephan SELL, Magdeburg (DE); Horst TIPPENHAUER, Erlangen (DE)

(21) Appl. No.: 18/991,158

(22) Filed: Dec. 20, 2024

(30) Foreign Application Priority Data
Dec. 22, 2023 (DE) 102023136532.0
Mar. 15, 2024 (DE) 102024107410.8

(51) Int. Cl. E06B 3/22; B29C 70/00; B29C 70/52; B29K 101/12

(52) U.S. Cl. CPC E06B 3/22; B29C 70/003; B29C 70/52; B29K 2101/12

(57) ABSTRACT

The present invention relates to a window or door hollow chamber profile (1), comprising (a) a core profile comprising a plastic matrix formed of a thermoplastic polyamide material and reinforcing fibres contained in the plastic matrix; and (b) a sheath profile (40) at least partially sheathing the core profile (30) and made of a thermoplastic material compatible with the plastic material of the core profile (30), wherein the window or door hollow chamber profile (1) is distinguished in accordance with the invention in that the thermoplastic material of the sheath profile (40) compatible with the plastic material of the core profile (30) is a blend of a polyamide material and an acrylonitrile-styrene-acrylic ester terpolymer (ASA). The present invention additionally relates to a window or door frame which is formed from portions of a window or door hollow chamber profile (1) according to the invention.

### FIELD OF THE INVENTION

The invention relates to a window or door hollow chamber profile comprising (a) a core profile comprising a plastic matrix formed of thermoplastic polyamide material and reinforcing fibres contained in the plastic matrix; and (b) a sheath profile at least partially sheathing the core profile and made of a thermoplastic material compatible with the plastic material of the core profile. Furthermore, the present invention relates to a window or door frame which is formed from portions of such a window or door hollow chamber profile.

### BACKGROUND OF THE INVENTION

For window and door hollow chamber profiles used to frame glass panes, the aim is to achieve the best possible thermal insulation of the resulting window or resulting door. In order to ensure the mechanical stability required for such windows or doors, it is necessary for static reasons to insert a usually metal reinforcement profile into at least one of the hollow chambers of the window or door hollow chamber profile for corresponding window or door hollow chamber profiles made of non-reinforced, thermoplastic material, for example polyvinylchloride (PVC), which improves the mechanical stability at the expense of the significantly deteriorated thermal insulation properties. To increase stability with good thermal insulation properties, DE 203 02 286 U1, for example, proposes the continuous fibre reinforcement of one or more regions of a window profile made of thermoplastic material, for example polyamide, with a fibre volume content of more than 20%. However, window and door profiles are exposed to different weather conditions. The lack of weather resistance of the fibre-reinforced polyamide window profiles described in DE 203 02 286 U1 is considered a disadvantage.

This is where the present invention comes in, which addresses the problem of providing a window or door hollow chamber profile that at least partially overcomes the disadvantages of the prior art. In particular, the window or door hollow chamber profile according to the invention should have high mechanical stability combined with good weather resistance. Furthermore, there is also an advantage in providing a window or door frame formed from portions of such a window or door hollow chamber profile.

These and other problems are solved according to the invention by a window or door hollow chamber profile having the features described herein or by a window or door frame having the features described herein. Preferred embodiments of the window or door hollow chamber profile according to the invention and of the window or door frame according to the invention are described in the dependent claims.

### SUMMARY OF THE INVENTION

In accordance with the present invention, it has surprisingly been recognised that the weather resistance of a polyamide-comprising window or door hollow chamber profile can be improved by providing at least the surface of the window or door hollow chamber profile facing the outside of the building in an installation situation with a weather-resistant layer of a blend of a polyamide material and an acrylonitrile-styrene-acrylic ester terpolymer (ASA). Such a layer is compatible with the polyamide of the core profile and can therefore be easily applied to the outer surface of the core profile in the course of the coextrusion.

Accordingly, the present invention lies in the provision of a window or door hollow chamber profile which comprises (a) a core profile with a plastic matrix formed from a polyamide material and reinforcing fibres contained in the plastic matrix; and (b) a sheath profile at least partially sheathing the core profile and made of a thermoplastic material compatible with the plastic material of the core profile, wherein the window or door hollow chamber profile according to the invention is further characterised in that the thermoplastic material of the sheath profile compatible with the plastic material of the core profile is a blend of a polyamide material and an acrylonitrile-styrene-acrylic ester terpolymer (ASA). In addition, the present invention provides a window or door frame, which is formed from portions of a window or door hollow chamber profile according to the invention, preferably obtained by welding together at least partially mitred portions of a window or door hollow chamber profile according to the invention.

As used herein, the term “polyamide material” means a polyamide to which the additives customary for the (co-)extrusion of window or door hollow chamber profiles, such as stabilisers, plasticisers, pigments and the like, have been added. Furthermore, the term “weather-side outer wall” as used herein describes the wall of the window or door hollow chamber profile according to the invention which faces the outside of the building when the window or door hollow chamber profile according to the invention is used as intended. Accordingly, the term “room-side outer wall” (the side opposite the weather side) as used herein describes that wall of the window or door hollow chamber according to the invention which, when the window or door hollow chamber profile according to the invention is used as intended, faces the room side of the window or door comprising the window or door hollow chamber profile according to the invention.

With regard to the window or door hollow chamber profile according to the invention, it may be preferable if the plastic material of the sheath profile contains the acrylonitrile-styrene-acrylic ester terpolymer (ASA) in a proportion of 10% by weight to 65% by weight, in relation to the weight of the sheath profile as 100% by weight. With a proportion of acrylonitrile-styrene-acrylic ester terpolymer within such a range, a balance of good weather resistance and compatibility with the core profile is achieved. From this point of view, a proportion of the acrylonitrile-styrene-acrylic ester terpolymer in the plastic material of the sheath profile in a range from 20% by weight to 55% by weight, in particular in a range from 30% by weight to 45% by weight, in each case in relation to the weight of the sheath profile as 100% by weight, has proved to be particularly advantageous.

It can also be advantageous if the thickness of the sheath profile is within a range from 0.3 mm to 1.5 mm, in particular in the range from about 0.4 mm to about 1.2 mm, preferably about 0.5 mm to about 0.9 mm and particularly preferably about 0.6 mm. A thickness of the outer layer in this range sufficiently covers any glass fibres occurring on the surface.

It may also be preferable if the weather-side outer wall and/or the room-side outer wall are at least partially formed by the sheath profile. As a result, the visible surfaces of the structural elements formed from the window or door hollow chamber profile according to the invention, i.e. corresponding windows or doors, are formed from the sheath profile. As a result, the surfaces of the window or door hollow chamber profile according to the invention that are exposed to changing heat and moisture conditions in an installation situation are provided with the sheathing layer that improves the weather resistance. In addition, the core profile, which may be rough on the surface, is concealed from the outside by the sheath profile on the visible surfaces. It is particularly preferable if the weather-side surface of the weather-side outer wall and/or the room-side surface of the room-side outer wall are formed by a preferably 0.3 mm to 1.5 mm thick layer of the sheath profile. The remaining wall thickness of the weather-side outer wall and/or the room-side outer wall can be formed by the core profile. As a result, smooth visible surfaces of the structural elements formed from the window or door hollow chamber profile according to the invention are maintained with very high mechanical stability of the formed frame. Preferably, the cover layer formed by the sheath profile has a thickness in the range of approximately 0.4 mm to approximately 1.2 mm, in particular approximately 0.5 mm to approximately 0.9 mm, particularly preferably approximately 0.6 mm.

It can also be useful if the polyamide of the core profile is selected from the group comprising polyamide-6 (PA 6), polyamide-6.6 (PA 6.6), polyamide-6.10 (PA 6.10), polyamide-4.6 (PA 4.6), polyamide-12 (PA 12) and blends of the aforementioned polyamides. Polyamide-6 is particularly favoured due to its good availability. Preferably, the polyamide of the core profile is also used as the thermoplastic material of the cover profile. In particularly preferred embodiments of the window or door hollow chamber profile according to the invention, polyamide 6 is used as the polyamide of the core profile and a blend of polyamide-6 and an acrylonitrile-acrylic ester-styrene copolymer is used as the thermoplastic material of the sheath profile.

Expediently, the reinforcing fibres are in the form of glass and/or carbon and/or aramid fibres and/or basalt fibres, wherein other fibre materials are not excluded. According to the invention, however, the use of glass fibres as reinforcing fibres contained in the plastic matrix of the core profile is preferred. In the context of the invention, it is preferred to use short glass fibres with a fibre length in the range from 0.1 mm to 5 mm, long glass fibres with a fibre length in the range from 5 mm to 50 mm and/or continuous glass fibres with a length of more than 50 mm, either individually or in combination. While the core profile is preferably produced by extrusion or coextrusion when using short and long glass fibres, the production of the window or door hollow chamber profile according to the invention by means of reactive pultrusion is most suitable when using continuous glass fibres. When using short glass fibres, it can also be advantageous if the average fibre length of the reinforcing fibres is in the range of 1.5 mm to 3.2 mm. An average length of the glass fibres in this range leads to a high mechanical stability of a window or door hollow chamber profile according to the invention, both in the longitudinal direction and perpendicular thereto. In this context, an average fibre length in a range of 2.5 mm to 3.0 mm has proven to be particularly suitable. According to the invention, the use of continuous glass fibres is also particularly preferred. There is the greatest need to improve the surface quality for continuous glass fibres. In addition, the highest stiffness and strength values with a modulus of elasticity according to DIN EN ISO 527-4: 2022-03 of up to 70,000 N/mm² in the longitudinal direction of the profile are achieved using continuous glass fibres.

It can also be helpful if the reinforcing fibres are contained in the core profile in a proportion of 10% to 90% by weight, in relation to the weight of the core profile as 100% by weight. If the proportion by weight of the reinforcing fibres in the core profile is within the range of 10% to 90% by weight, in relation to the weight of the core profile as 100% by weight, excellent moduli of elasticity according to DIN EN ISO 527-4: 2022-03 and corresponding core profiles can be produced, for example, by means of reactive pultrusion. In this context, it is preferable if the proportion by weight of the reinforcing fibres in the core profile is within the range of 20% by weight to 80% by weight, in particular 30% by weight to 60% by weight, in each case in relation to the weight of the core profile as 100% by weight.

Preferably, the outer layer is coextruded with the core profile. The term “coextrusion”, as used herein, also means in this context the application of the coating to the freshly produced core profile by means of an extrusion immediately following the reactive pultrusion or the extrusion of the core profile online, wherein in this case the intermediate cooling of the core profile prior to the application of the sheath profile is also within the scope of the invention. Alternatively, in coextrusion, the core profile and the coating can be produced in a common mould.

All plastic materials in the window or door hollow chamber profile according to the invention can also be used in the form of materials obtained by a recycling process. In particular, it is preferable that a recycled polyamide is contained in the core profile. In addition or alternatively, “fresh”, i.e. non-recycled, polymer material can also be used in the sheath profile.

Particularly preferably, the core profile of the window or door hollow chamber profile according to the invention can be produced in a manner known per se by coextrusion of the core profile and the sheath profile.

Preferably, the window or door hollow chamber profiles according to the invention are used to manufacture a plastic window or a plastic door. A window or door frame can be obtained by welding mitre-cut pieces of a window or door hollow chamber profile according to the invention or connecting such pieces by means of corresponding corner connectors. The window or door frame is intended for installation in an opening in a wall of a building or can be installed in the opening in the wall of a building.

The explanations with regard to the window or door hollow chamber profile according to the invention apply accordingly with regard to the method according to the invention.

With regard to the method according to the invention, it is preferable if the core profile, possibly together with the sheath profile, is produced by means of extrusion, coextrusion or pultrusion, in particular by means of reactive pultrusion.

All plastic materials in the window or door hollow chamber profile according to the invention can also be used in the form of materials obtained by a recycling process. In particular, it is preferable that a recycled polyamide is contained in the core profile. In addition or alternatively, “fresh”, i.e. non-recycled, polymer material can also be used in the sheath profile.

Particularly preferably, the window or door hollow chamber profile according to the invention can be produced in a manner known per se by coextrusion of the core profile and the sheath profile.

Preferably, the window or door hollow chamber profiles according to the invention are used to manufacture a plastic window or a plastic door. A window or door frame according to the invention can be obtained by welding mitre-cut pieces of a window or door hollow chamber profile according to the invention. The window or door frame according to the invention is intended for installation in an opening of a wall of a building or can be installed in the opening of the wall of a building.

The explanations with regard to the window or door hollow chamber profile according to the invention apply accordingly with regard to the window or door frame according to the invention.

The window or door hollow chamber according to the invention and individual parts thereof can also be manufactured line by line or layer by layer using a line-building or layer-building manufacturing process (e.g. 3D printing), but manufacturing by means of coextrusion is preferred.

### BRIEF DESCRIPTION OF THE DRAWINGS

In the following, the present invention will be explained in detail with reference to the embodiments shown in the figures. FIG. 1 shows a cross-sectional representation of a window or door hollow chamber profile designed as a window sash profile according to one embodiment of the present invention.

FIG. 1 shows an embodiment of the window or door hollow chamber profile 1 according to the invention using the example of a sash profile for a plastic window in a cross-sectional view. The window or door hollow chamber profile 1 according to the invention comprises a weather-side outer wall 2 and a room-side outer wall 3. Two cavities 4, 5 adjoin the weather-side outer wall 2 and are bounded by walls 6, 6′, 6″ formed as webs and the weather-side outer wall 2. In the centre, the hollow chamber profile 1 according to the invention comprises a main cavity 7. The upper web 8 of the main cavity 7, together with an outer folded-over portion 5, forms a rebate region 10, in which a panel element, not shown, in particular an insulating glazing unit, can be accommodated. The panel element is stabilised by a glazing bead (not shown), which can be anchored in a glazing bead groove 11 of the hollow chamber profile 1 according to the invention. The outer wall 12 of the hollow chamber profile 1 according to the invention, which is arranged at the bottom in FIG. 1, is referred to as the fitting-side profile outer wall 12, while the side opposite the fitting side is referred to as the rebate side with a rebate-side profile outer wall 13.

### DETAILED DESCRIPTION OF EMBODIMENTS OF THE INVENTION

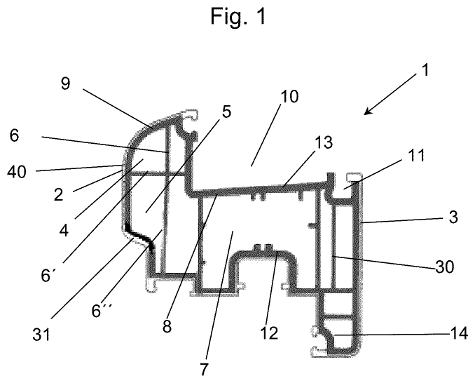

In the embodiment of the window or door hollow chamber profile 1 according to the invention shown in FIG. 1, the central region, which comprises, for example, the walls 6, 6′, 6″, the inner parts of the weather-side outer wall 2, the room-side outer wall 3, and that of the fitting-side profile outer wall 12, portions of the glazing bead groove 11, the rebate-side profile outer wall 13 and parts of the stop 14, is formed by a core profile 30. The parts of the weather-side outer wall 2, the room-side outer wall 3 and the fitting-side outer wall 12 of the profile that face the outside of the profile, as well as regions of a stop 14, are formed by a sheath profile 40. The core profile 30 is thus partially enveloped by an approximately 0.7 mm thick cover layer of the sheath profile 40. The sheath profile 40 largely forms the outer side of the window or door hollow chamber profile 1 according to the invention, while the core profile is only exposed to the outside in the region of the rebate-side profile outer wall 13 and adjacently thereto.

According to the embodiment of the window or door hollow chamber profile 1 according to the invention shown in FIG. 1, the core profile 30 comprises a plastic matrix of polyamide 6, to which additives customary for the extrusion of window or door hollow chamber profiles, such as stabilisers, plasticisers, pigments and the like, are added. For reinforcement, short glass fibres with an average fibre length of 2.6 mm are embedded in the plastic matrix in a proportion of 48% by weight, in relation to the weight of the core profile 30 as 100% by weight. The sheath profile 40 forms a blend of polyamide 6 with acrylonitrile-acrylic ester-styrene terpolymer (ASA), wherein the usual additives for the extrusion of window or door hollow chamber profiles have also been added to the blend.

The proportion of acrylonitrile-acrylic ester-styrene terpolymer in the blend was varied over a range of 10% by weight to 65% by weight, in relation to the total weight of the sheath layer 40. These blends are compatible with the core profile 30. The window or door hollow chamber profiles 1 according to the invention obtained in this way and the core profile 30 (without sheath layer 40) as a reference example were subjected to a weathering test according to DIN EN ISO 4892-2:2021-11 (method B).

The profiles 1 according to the invention showed a greatly improved weathering behaviour compared to the reference example (core profile 30 without sheath layer 40).

The window or door hollow chamber profile 1 according to the embodiment of the present invention shown in FIG. has a very good weather resistance and has a high mechanical stability both in the longitudinal direction (modulus of elasticity according to DIN EN ISO 527-4: 2022-03 of 9,200 N/mm²) and perpendicular thereto.

The window or door hollow chamber profile 1 according to the invention was produced by coextruding the core profile 30 and the sheath profile 40. Polyamide 6 obtained by a recycling process was used for the core profile 30, while non-recycled polymer material was used for the sheath profile 40.

Despite the high short glass fibre content in the core profile 30, the window or door hollow chamber profile 1 according to the invention can be welded using methods known to a person skilled in the art to form a window or door frame according to the invention without the need to take additional measures over and above standard methods for welding plastic profiles. For this purpose, corresponding portions are cut to length from the window or door hollow chamber profile 1 according to the invention, mitred and welded together using a welding table to form a window frame according to the invention. The resulting corner joint according to the invention has a high corner strength.

The present invention has been described by way of example with reference to hollow chamber profiles for the sash frame of a window. It is understood that the present invention is also applicable to other window or door hollow chamber profiles, in particular frame profiles for a window as well as for frame, architrave or sash frame profiles of a door accordingly.

1. A window or door hollow chamber profile, comprising
(a) a core profile comprising a plastic matrix formed of a thermoplastic polyamide material and reinforcing fibres contained in the plastic matrix; and
(b) a sheath profile at least partially sheathing the core profile and made of a thermoplastic material compatible with the plastic material of the core profile,
wherein
the thermoplastic material of the sheath profile compatible with the plastic material of the core profile is a blend of a polyamide material and an acrylonitrile-styrene-acrylic ester terpolymer (ASA).

2. The window or door hollow chamber profile according to claim 1, wherein the plastic material of the sheath profile contains the acrylonitrile-styrene-acrylic ester terpolymer (ASA) in a proportion of 10% by weight to 65% by weight, in relation to the weight of the sheath profile as 100% by weight.

3. The window or door hollow chamber profile according to claim 1, wherein the thickness of the sheath profile is within a range from 0.3 mm to 1.5 mm.

4. The window or door hollow chamber profile according to claim 1, wherein a weather-side outer wall and/or a room-side outer wall are at least partially formed by the sheath profile.

5. The window or door hollow chamber profile according to claim 4, wherein the weather-side surface of the weather-side outer wall and/or the room-side surface of the room-side outer wall are formed by a layer of the sheath profile.

6. The window or door hollow chamber profile according to claim 5, wherein the polyamide of the core profile is selected from the group comprising polyamide-6 (PA 6), polyamide-6.6 (PA 6.6), polyamide-6.10 (PA 6.10), polyamide-4.6 (PA 4.6), polyamide-12 (PA 12) and blends of the aforementioned polyamides.

7. The window or door hollow chamber profile according to claim 1, wherein it is produced by means of extrusion, coextrusion or pultrusion, in particular by means of reactive pultrusion.

8. The window or door hollow chamber profile according to claim 1, wherein the reinforcing fibres are formed as glass and/or carbon and/or aramid fibres and/or basalt fibres.

9. A window or door frame, which is formed from portions of a window or door hollow chamber profile according to claim 1.
